(19) United States
(12) Patent Application Publication
(10) Pub. No.: US 2014/0074395 A1
(43) Pub. Date: Mar. 13, 2014

(54) Method of displaying points of interest and related portable electronic device

(71) Applicant: Michael Brown, Auckland (NZ)

(72) Inventor: Michael Brown, Auckland (NZ)

(21) Appl. No.: 13/612,887

(22) Filed: Sep. 13, 2012

(51) Int. Cl. G01C 21/00; G01C 21/34

(52) U.S. Cl. 701/424; 701/425

(57) ABSTRACT

A method of displaying points of interest to a user of a portable electronic device includes receiving an input from a user for entering a destination location into the portable electronic device for generating navigation instructions to the destination location, determining a current location of the portable electronic device according to received position signals, and providing navigation instructions to the destination location along a suggested navigation route according to the current location of the portable electronic device. The method further includes displaying points of interest located within a display area of a map shown on a display of the portable electronic device according to weighted scores assigned to the points of interest, where the weighted scores are modified according to the relevance of the points of interest to the suggested navigation route, and the points of interest having higher weighted scores are displayed.

### BACKGROUND OF THE INVENTION

1. Field of the Invention

The invention relates to a method of displaying points of interest on a portable electronic device, and more particularly, to a method for assigning weighted scores to points of interest for displaying the most relevant points of interest to the user.

2. Description of the Prior Art

Global Positioning System (GPS) based navigation devices are well known and are widely employed as in-car navigation devices. Common functions of a navigation device include providing a map database for generating navigation instructions that are then shown on a display of the navigation device. These navigation devices are often mounted on or in the dashboard of a vehicle using a suction mount or other mounting means.

The term “navigation device” refers to a device that enables a user to navigate to a pre-defined destination. The device may have an internal system for receiving location data, such as a GPS receiver, or may merely be connectable to a receiver that can receive location data. The device may compute a route itself, or communicate with a remote server that computes the route and provides navigation information to the device, or a hybrid device in which the device itself and a remote server both play a role in the route computation process. Personal GPS navigation devices are not permanently integrated into a vehicle but instead are devices that can readily be mounted in or otherwise used inside a vehicle. Generally (but not necessarily), they are fully self-contained—i.e. include an internal GPS antenna, navigation software and maps and can hence plot and display a route to be taken.

One useful feature of personal navigation devices is the ability to list nearby points of interest (POIs). In rural areas, points of interest may be spread out far from each other, and can easily be shown on the display of the personal navigation device. However, when traveling through cities or other areas where there are many points of interest in close proximity to one another, there can be tens of points of interest located very close together.

When looking at a map with points of interest present, legibility is impaired when there are a large number of points of interest on a small area of the screen. Each point of interest is represented by an icon. If all the icons are shown at once, then very few of the icons are actually fully visible and much of the map is obscured. When points of interest are clustered together, this makes it difficult to select one of the points of interest in a cluster.

Please refer to FIG. 1. FIG. 1 illustrates a map 5 containing many icons representing points of interest 2 in a small area. If a user wishes to select a point of interest for either finding out more information about it or for receiving navigation instructions to the point of interest, this can be difficult to do if there are many icons clustered together. As an example, area 4 on the map 5 has many points of interest 2 grouped nearby one another, making it difficult for a user to distinguish among the points of interest located in area 4.

From the above, it can be seen that it is difficult to clearly show multiple points of interest that are in very close proximity to each other on the display of a personal navigation device. To deal with this problem, the prior art has used several different approaches for presenting information about points of interest to users of personal navigation devices.

One method used in the prior art is assigning different priority levels to different types of points of interest. For instance, an office building can be given a low priority while a hospital or a tourist attraction can be given higher priority. Once the priority levels have been established, the personal navigation device can be set to only display points of interest having a priority level equal or greater than a minimum priority. Otherwise, if there are still many points of interest meeting the minimum priority level, the personal navigation device will display only the points of interest with the greatest priority level.

As the map view is zoomed out, the minimum priority required for a point of interest to be displayed is increased. Additionally, points of interest which are spatially close together can be grouped together under a single icon, which when selected shows in some form the points of interest that have been combined together.

While this approach solves the issue of the map or icon being hidden, it does not provide a useful indication to the user as to what points of interest are present without looking at the contents of each group. Additionally, it does not show useful points of interest close to the current location when the map is significantly zoomed out.

Another problem with traditional approaches to displaying points of interest is that if several points of interest occur at the same location or nearby locations, only one type of point of interest icon may be drawn, which will be the icon representing the point of interest having the highest priority level. A different related problem is if a point of interest has been selected as a target destination for a user's trip, it may not be shown on the map if this type of point of interest was not enabled or not given high enough priority.

Other problems come when the areas displayed on the map change when a user continues driving. As the map point of view changes, points of interest will appear and disappear from the map as their relative positions and priorities vary over time. Having icons constantly appear and disappear can be distracting to users.

Many personal navigation device manufacturers include more points of interest on a map than necessary for the average user because they want the user to appreciate all of the points of interest that the personal navigation device displays. However, most of the time, users are not interested in many of these points of interest. For example, restaurants, Automated Teller Machines (ATMs), etc. are only of interest when you need them, and are not required for every day driving.

After points of interest are displayed on the map, the user may find out more information about one of the points of interest by selecting it. However, if the point of interest that they are interested in is not shown as one of the displayed types of points of interest, they do not have this option. Instead, they may need to zoom in and move the map around in order to display the point of interest that they know is enabled. This may cause confusion as to why they are not able to find the specific point of interest on the map when they know that the point of interest is actually there.

Another problem comes when the user touches a map at a specific location containing multiple points of interest. In this case, the personal navigation device cannot tell which point of interest the user is interested in, and cannot show them the correct location details.

A prior art solution to the above problems is to only display points of interest that are relevant to the user's trip purpose, such as business, tourism or travel, shopping, etc. Unrelated points of interest are not shown, thereby reducing clutter and increasing the user's interest in the remaining points of interest by keeping the points of interest appropriate for the purpose of the user's trip. While this approach is useful, it requires the user to first input a trip purpose, which is an extra step required of the user.

### SUMMARY OF THE INVENTION

It is therefore one of the primary objectives of the claimed invention to provide a method for displaying points of interest to a user of a portable electronic device in order to clearly display multiple points of interest. The points of interest have corresponding weighted scores indicating their perceived relevance to the user, and only the points of interest having higher weighted scores are displayed on the screen.

According to an exemplary embodiment of the claimed invention, a method of displaying points of interest to a user of a portable electronic device is disclosed. The method includes receiving an input from a user for entering a destination location into the portable electronic device for generating navigation instructions to the destination location, determining a current location of the portable electronic device according to received position signals, and providing navigation instructions to the destination location along a suggested navigation route according to the current location of the portable electronic device. The method further includes displaying points of interest located within a display area of a map shown on a display of the portable electronic device according to weighted scores assigned to the points of interest, wherein the weighted scores are modified according to the relevance of the points of interest to the suggested navigation route, and the points of interest having higher weighted scores are displayed.

According to another exemplary embodiment of the claimed invention, a portable electronic device for displaying points of interest to a user is disclosed. The portable electronic device includes a position receiving device receiving position signals indicating a current location of the portable electronic device, a map database for storing map data including road information, and routing software for receiving a destination location from the user and generating navigation instructions to the destination location along a suggested navigation route according to the current location of the portable electronic device. The portable electronic device also includes a display for displaying points of interest located within a display area of a map shown on the display according to weighted scores assigned to the points of interest, wherein the weighted scores are modified according to the relevance of the points of interest to the suggested navigation route, and the points of interest having higher weighted scores are displayed.

It is an advantage that the present invention displays only the points of interest having higher weighted scores so as to avoid cluttering a display of the portable electronic device with too many points of interest that block what is being shown on an underlying map. By using information about the suggested navigation route that the user is traveling on, the points of interest selected to be shown on the display can be chosen to provide the most useful information to the user. Points of interest that are most likely to be chosen can be shown individually, and points of interest less likely to be chosen can be put into groups for decreasing clutter on the display. The present invention approach allows easier identification and selection of interesting points of interest, even when the view is significantly zoomed out.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a map containing many icons representing points of interest in a small area.

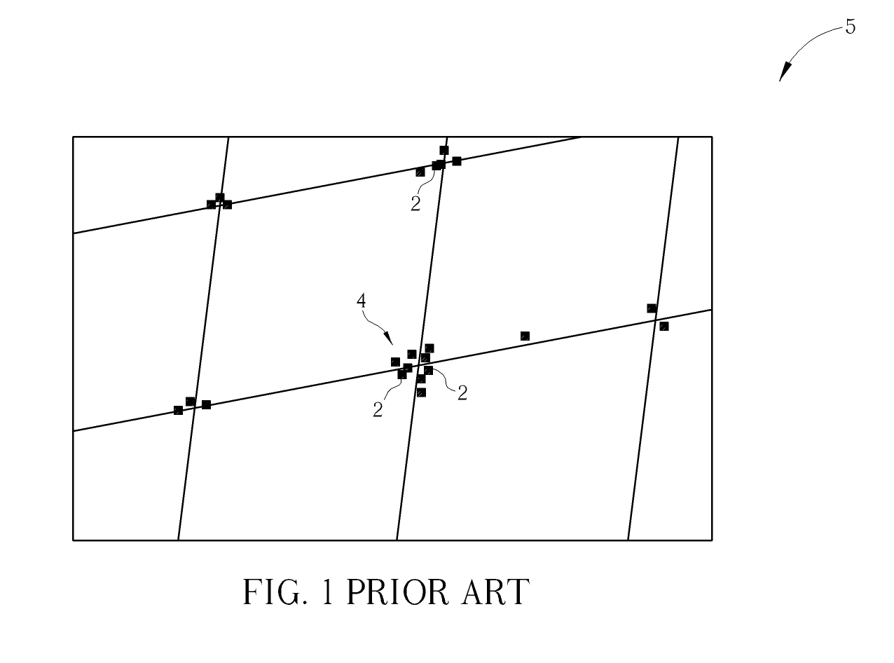

FIG. 2 is a block diagram of a portable electronic device according to the present invention.

FIG. 3 is a flowchart illustrating the present invention method of contextually displaying points of interest on the portable electronic device.

FIG. 4 illustrates a map showing roads and points of interest. A user is located at a current position following the suggested navigation route on a path towards the top of the map.

### DETAILED DESCRIPTION

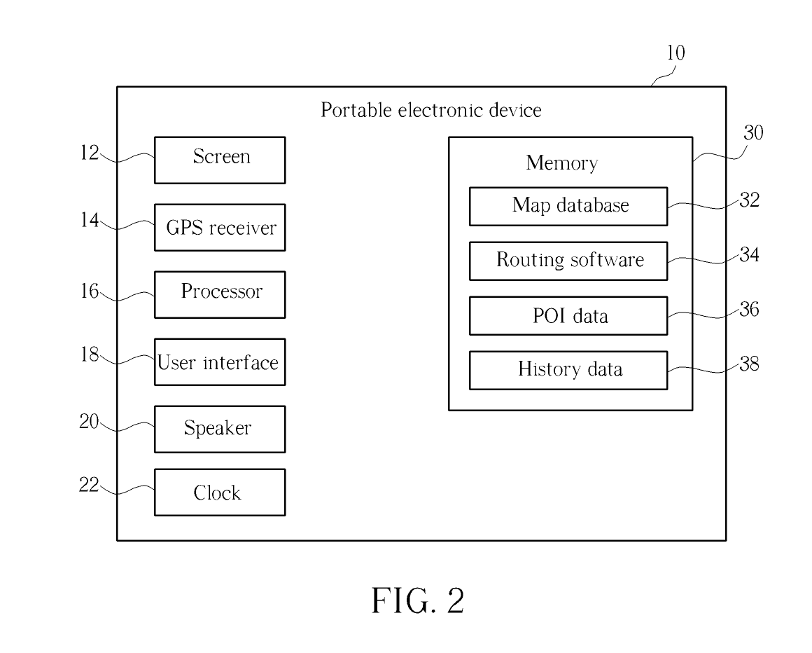

Please refer to FIG. 2. FIG. 2 is a block diagram of a portable electronic device 10 according to the present invention. The portable electronic device 10 contains a screen 12 which can be a touch-sensitive screen, a Global Positioning System (GPS) receiver 14 for receiving the current coordinates of the portable electronic device 10, a processor 16 for controlling operation of the portable electronic device 10, a user interface 18, a speaker 20, a clock 22, and memory 30. The memory 30 is used to store a map database 32 containing map data and points of interest. The memory 30 also stores routing software 34, point of interest data 36, and history data 38.

The point of interest data 36 stores a plurality of points of interest, and each point of interest may have at least one corresponding point of interest category label and brand label. Common category labels include “gas station”, “restaurant”, “hotel”, “bank”, “coffee shop”, and so on. To make it easier to identify the different categories of points of interest, each category may also have its own unique icon such as a dollar sign “$” for a bank. Points of interest can also be grouped under brands labels, such as the Starbucks™ brand of coffee shops. Each of the points of interest will also have a weighted score assigned to it that is updated in real time as the vehicle that the portable electronic device 10 is located in travels along a suggested navigation route generated by the portable electronic device 10. As will be explained below, the weighted scores indicate which points of interest are most relevant to the user's suggested navigation route according to a variety of factors. In other words, points of interest shown on the screen 12 are filtered according to their weighted scores.

The history data 38 can store data related to how many times and how frequently the user of the portable electronic device 10 has visited or stopped at various points of interest. This history data 38 can then be used when calculating the weighted scores of the points of interest to be stored in the points of interest data 36.

When the user requests navigation assistance to a destination location, the routing software 34 will generate a suggested navigation route for the user to follow and will provide navigation instructions to the user along the way. If the routing software 34 generates two or more suggested navigation routes, then the user can have the opportunity to select which one of the suggested navigation routes the user would like to receive navigation instructions for.

The GPS receiver 14 receives GPS signals and indicates a current location of the portable electronic device 10. Please note that other satellite or terrestrial positing receiving devices besides the GPS receiver 14 could be used instead for receiving position signals. When creating the suggested navigation route for the user to follow, the routing software 34 determines which points of interest stored in the points of interest data 36 will be nearby the suggested navigation route.

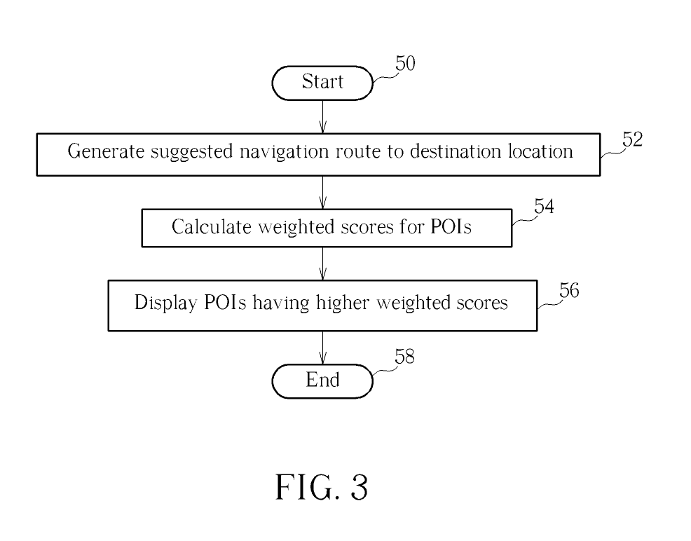

Please refer to FIG. 3. FIG. 3 is a flowchart illustrating the present invention method of contextually displaying points of interest on the portable electronic device 10. Steps contained in the flowchart will be explained below.

Step 50: Start.

Step 52: The routing software 34 of the portable electronic device 10 generates a suggested navigation route according to the current location of the portable electronic device 10 and a destination location entered by the user.

Step 54: The portable electronic device 10 calculates the weighted scores for points of interest that are nearby the suggested navigation route. The algorithm for calculating the weighted scores can consider many factors, as will be explained below.

Step 56: Display the points of interest having higher weighted scores for a given map size shown on the screen 12 of the portable electronic device 10. That is, for a given portion of a map and zoom level of the map being displayed on the screen 12, the points of interest having higher weighted scores are shown. Points of interest that are most likely to be chosen can be shown individually, and points of interest less likely to be chosen can be put into groups for decreasing clutter on the screen 12.

Step 58: End.

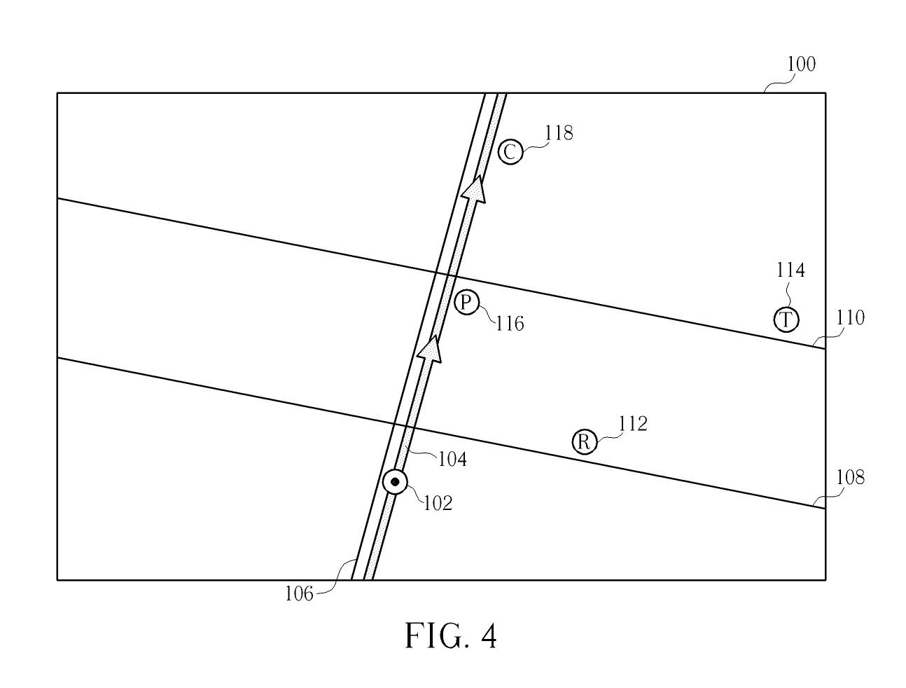

Please refer to FIG. 4. FIG. 4 illustrates a map 100 showing roads 106, 108, and 110 and points of interest 112, 114, 116, and 118. A user is located at a current position 102 following the suggested navigation route 104 on a path towards the top of the map 100. The suggested navigation route 104 follows road 106, and the current position 102 of the user is located just below the intersection of road 106 with road 108. Point of interest 112 corresponds to a restaurant, point of interest 114 corresponds to a tourist attraction, point of interest 116 corresponds to a petrol station (also known as a gas station), and point of interest 118 corresponds to a coffee shop.

In the present invention, instead of treating all points of interest as equal, each point of interest that is near the suggested navigation route 104 can be given a weighted score. This weighted score can depend on a number of factors.

A first factor affecting the weighted scores is a distance from a point of interest to the suggested navigation route 104. Points of interest can be thought of as having a “reach”, or a distance which someone will travel to visit the point of interest. The distance that a user will be willing to travel for a tourist attraction, such as point of interest 114 shown in FIG. 4, will be significantly more than for a petrol station, such as point of interest 116. So a petrol station far from the suggested navigation route 104 would obtain a low weighted score for this factor, whereas a tourist attraction at the same distance would obtain a higher weighted score. The weighted score can decrease according to an increasing distance from a point of interest to the suggested navigation route 104. Each category of points of interest can have its own predetermined distance within which the weighted scores remain at their highest, and the weighted scores can gradually decrease after the distance from the points of interest to the suggested navigation route 104 exceeds the predetermined distance.

The weighted scores according to distance from the suggested navigation route 104 would also depend on the density of a particular point of interest category in the area. For example, if there are no other petrol stations within a large distance of a petrol station near the suggested navigation route 104, but there are a large number of other points of interest nearby, then the lone petrol station would have an increased weighted score according to the ratio of the number of petrol stations to the number of other points of interest. This is similar to the previously-mentioned priority of the point of interest, except it now takes into account the distance from the suggested navigation route 104 to the point of interest. The weighted scores may also depend on the density of points of interest within a particular point of interest category in an area without considering other point of interest categories. For example, if there is only one petrol station in a neighborhood, this petrol station would have a much higher weighted score than it would if there were two petrol stations in the same neighborhood. Thus, the weighted values of points of interest within the particular point of interest category can be modified without computing a ratio according to the total number of all points of interest in the area, and the weighted values are inversely related to the number of points of interest in the point of interest category located in the area.

A second factor affecting the weighted scores is historical user preferences, which are stored in the history data 38. If the user of the portable electronic device 10 has frequently visited a particular point of interest, the weighted score of that point of interest would be increased by a high amount. A smaller increase would be given to points of interest of the same brand. For example, if most of the coffee shops visited by the user were Starbucks™ brand coffee shops, then the weighted score of all Starbucks™ coffee shop points of interest would be increased. Finally, a smaller again weighted score would be given to points of interest of the same category. Therefore three different magnitudes of weighted scores could be assigned to a point of interest based data recorded in the history data 38.

To state a different way, the weighted scores for particular points of interest previously visited would be increased by a large amount, the weighted scores for the same brand of points of interest previously visited would be increased by a medium amount, and the weighted scores for the same category of points of interest previously visited would be increased by a small amount. The portable electronic device 10 can detect visits to particular points of interest when a user selects the particular points of interest as waypoints or destination locations on a navigation route, or when the portable electronic device 10 detects a stop at the particular points of interest for a length of time exceeding a minimum time threshold.

A third factor affecting the weighted scores is current contextual information. If the user has been driving along a freeway for a significant distance, then petrol stations would obtain an increased weighted score since it is likely that the user's vehicle requires fuel. Additionally, on-board diagnostics (OBD), such as those adhering to the OBD-II standard diagnostic specification, may be used to indicate the fuel gauge of the user's vehicle. This information could be used to determine petrol stations that the user may wish to stop at in the future when the fuel level of the vehicle is below a certain level. The on-board diagnostics could also be used for determining when the vehicle's malfunction indicator light, also referred to as a check engine light, comes on. If the malfunction indicator light is illuminated, then the weighted scores for vehicle repair shops could be raised significantly in order to let the user know about vehicle repair shops where the user's vehicle can be serviced.

The time and date indicated by the clock 22 of the portable electronic device 10 can also be used for adjusting the weighted scores. For instance, the weighted score of restaurants would increase if the time at which the user would reach the restaurant would be a typical meal time. Again, historical user activity stored in the history data 38 can be used to indicate, for example, preferred petrol stations for refueling, preferred times of day for eating, or even preferred restaurants for eating at. Any number of such rules can be used to adjust the weighted scores for categories of points of interest.

Once weighted scores have been determined for the various points of interest located within a map area being shown on the screen 12 of the portable electronic device 10, it is possible to pick a number of the points of interest for individual display based on the weighted scores of the points of interest. This would allow the user to quickly route to places that may be of interest, even when the map is significantly zoomed out, where a large number of points of interest would be within the visible map shown on the screen 12. In other words, when the view of the map is significantly zoomed out, the points of interest included in the list of the displayed points of interest having higher weighted scores will still be displayed. Any remaining points of interest, which can also be filtered based on their weighted score to avoid thousands of points of interest being shown on the screen 12, can be processed using existing decluttering algorithms. Points of interest can be combined into point of interest groups, which can be inspected for a list of contained points of interest.

Calculating the weighted scores requires some computation to be performed by the processor 16 of the portable electronic device 10. Some of the computation can be performed beforehand. For example, the reach of a point of interest, or distance which someone will travel to visit the point of interest, can be stored in the points of interest data 36 based on precomputation of point of interest density, etc. Additionally, the list of the displayed points of interest having higher weighted scores does not need to be updated for every frame shown on the screen 12 of the portable electronic device 10. A background exploration process can be run in order to update weighted scores for points of interest, to rescore points of interest according to changing conditions, and to keep a list of the points of interest with higher weighted scores.

The portable electronic device 10 of the present invention may be any device that is capable of providing navigation instructions to a user. For instance, the portable electronic device 10 can be a personal navigation device (PND), a mobile phone, a personal digital assistant (PDA), or other similar devices that have at least a position receiving device such as the GPS receiver 14 and a map database.

In summary the present invention performs point of interest filtering by displaying only the points of interest having higher weighted scores, so as to avoid cluttering a display of the portable electronic device with too many points of interest and to avoid blocking what is being shown on an underlying map. By using information about the suggested navigation route that the user is traveling on such as the destination location or the points along the suggested navigation route, the points of interest selected to be shown on the display can be chosen to provide the most useful information to the user. Points of interest that are most likely to be chosen can be shown individually, and points of interest less likely to be chosen can be put into groups for decreasing clutter on the display. The present invention approach allows easier identification and selection of interesting points of interest.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of displaying points of interest to a user of a portable electronic device, the method comprising:
receiving an input from a user for entering a destination location into the portable electronic device for generating navigation instructions to the destination location;
determining a current location of the portable electronic device according to received position signals;
providing navigation instructions to the destination location along a suggested navigation route according to the current location of the portable electronic device; and
displaying points of interest located within a display area of a map shown on a display of the portable electronic device according to weighted scores assigned to the points of interest, wherein the weighted scores are modified according to the relevance of the points of interest to the suggested navigation route, and the points of interest having higher weighted scores are displayed.

2. The method of claim 1, wherein the weighted scores are modified according to a distance from points of interest to the suggested navigation route, points of interest closer to the suggested navigation route have higher weighted scores than points of interest farther from the suggested navigation route, and weighted scores for points of interest belonging to a first category and located within a predetermined distance from the suggested navigation route are higher than weighted scores for points of interest belonging to a second category and located within the predetermined distance from the suggested navigation route.

3. The method of claim 1, wherein the weighted scores are modified according to a ratio of a first quantity to a second quantity, the first quantity being defined as a number of points of interest belonging to a category and located in an area near the suggested navigation route, and the second quantity being defined as a total number of points of interest located in the area near the suggested navigation route, and the weighted scores for the points of interest belonging to the category are inversely related to the value of the ratio.

4. The method of claim 1, wherein the weighted scores are modified according to a number of points of interest belonging to a category and located in an area, and the weighted scores for the points of interest belonging to the category are inversely related to the number of point of interest belonging to the category and located in the area.

5. The method of claim 1, wherein the weighted scores are modified according to a historical frequency of visits the user has made to the points of interest, and the weighted scores for the points of interest are directly related to the historical frequency of visits.

6. The method of claim 5, wherein weighted scores for specific points of interest previously visited are increased by a first factor according to the historical frequency of visits the user has made to the points of interest, weighted scores for points of interest belonging to a same brand of points of interest previously visited are increased by a second factor according to the historical frequency of visits the user has made to the points of interest, weighted scores for points of interest belonging to a same category of points of interest previously visited are increased by a third factor according to the historical frequency of visits the user has made to the points of interest, the second factor is less than the first factor, and the second factor is greater than the third factor.

7. The method of claim 5, wherein visits made to the points of interest are detected when the user selects the points of interest as waypoints or destination locations, or when the portable electronic device detects stops at the points of interest for a length of time exceeding a minimum time threshold.

8. The method of claim 1, wherein the weighted scores are modified according to a current time and date.

9. The method of claim 1, wherein the weighted scores are modified according to a fuel level for a vehicle driven by the user as indicated by a fuel gauge level of the vehicle.

10. The method of claim 1, wherein when a view of the map is zoomed out, the points of interest having higher weighted scores are still displayed.

11. A portable electronic device for displaying points of interest to a user, the portable electronic device comprising:
a position receiving device receiving position signals indicating a current location of the portable electronic device;
a map database for storing map data including road information;
routing software for receiving a destination location input from the user and generating navigation instructions to the destination location along a suggested navigation route according to the current location of the portable electronic device; and
a display for displaying points of interest located within a display area of a map shown on the display according to weighted scores assigned to the points of interest, wherein the weighted scores are modified according to the relevance of the points of interest to the suggested navigation route, and the points of interest having higher weighted scores are displayed.

12. The portable electronic device of claim 11, wherein the weighted scores are modified according to a distance from points of interest to the suggested navigation route, points of interest closer to the suggested navigation route have higher weighted scores than points of interest farther from the suggested navigation route, and weighted scores for points of interest belonging to a first category and located within a predetermined distance from the suggested navigation route are higher than weighted scores for points of interest belonging to a second category and located within the predetermined distance from the suggested navigation route.

13. The portable electronic device of claim 11, wherein the weighted scores are modified according to a ratio of a first quantity to a second quantity, the first quantity being defined as a number of points of interest belonging to a category and located in an area near the suggested navigation route, and the second quantity being defined as a total number of points of interest located in the area near the suggested navigation route, and the weighted scores for the points of interest belonging to the category are inversely related to the value of the ratio.

14. The portable electronic device of claim 11, wherein the weighted scores are modified according to a number of points of interest belonging to a category and located in an area, and the weighted scores for the points of interest belonging to the category are inversely related to the number of point of interest belonging to the category and located in the area.

15. The portable electronic device of claim 11, wherein the weighted scores are modified according to a historical frequency of visits the user has made to the points of interest, and the weighted scores for the points of interest are directly related to the historical frequency of visits.

16. The portable electronic device of claim 15, wherein weighted scores for specific points of interest previously visited are increased by a first factor according to the historical frequency of visits the user has made to the points of interest, weighted scores for points of interest belonging to a same brand of points of interest previously visited are increased by a second factor according to the historical frequency of visits the user has made to the points of interest, weighted scores for points of interest belonging to a same category of points of interest previously visited are increased by a third factor according to the historical frequency of visits the user has made to the points of interest, the second factor is less than the first factor, and the second factor is greater than the third factor.

17. The portable electronic device of claim 15, wherein visits made to the points of interest are detected when the user selects the points of interest as waypoints or destination locations, or when the portable electronic device detects stops at the points of interest for a length of time exceeding a minimum time threshold.

18. The portable electronic device of claim 11, wherein the weighted scores are modified according to a current time and date.

19. The portable electronic device of claim 11, wherein the weighted scores are modified according to a fuel level for a vehicle driven by the user as indicated by a fuel gauge level of the vehicle.

20. The portable electronic device of claim 11 when a view of the map is zoomed out, the points of interest having higher weighted scores are still displayed.
